(19) United States
(12) Patent Application Publication
(10) Pub. No.: US 2018/0249115 A1
(43) Pub. Date: Aug. 30, 2018

(54) MOBILE CAPTURE EXPERIENCE FOR RIDES

(71) Applicant: PANASONIC INTELLECTUAL PROPERTY MANAGEMENT CO., LTD., Osaka (JP)

(72) Inventors: John CRONIN, Bonita Springs, FL (US); Jonathan T. GOGUEN, Brookline, NH (US); Seth Melvin CRONIN, Essex Junction, VT (US); Yoshihiro OKUMURA, Osaka (JP)

(73) Assignee: PANASONIC INTELLECTUAL PROPERTY MANAGEMENT CO., LTD.

(21) Appl. No.: 15/906,584

(22) Filed: Feb. 27, 2018

Related U.S. Application Data
(60) Provisional application No. 62/464,873, filed on Feb. 28, 2017.

(51) Int. Cl. H04N 5/77; H04N 7/18; H04N 5/232; H04N 5/92; G11B 27/031

(52) U.S. Cl. CPC H04N 5/77; H04N 7/181; G11B 27/031; H04N 5/9201; H04N 5/23219

(57) ABSTRACT

A system and method for linking mobile devices wirelessly to a capture and distribution system associated with a ride (i.e. roller coaster) is described herein. The capture and distribution system would be used to facilitate documentation of the user's experience on that ride via pictures, video and/or audio recordings. The capture and distribution system may be set up so as to provide a personal documentation of each user's experience. After the ride has been completed, the capture and distribution system can provide the pictures, video and/or audio recordings wirelessly to the user's mobile device.

### RELATED APPLICATIONS

This application claims priority of the U.S. Provisional Application No. 62/464,873 filed on Feb. 28, 2017, the entire contents of which are incorporated herein by reference.

### BACKGROUND

### Technical Field

The present disclosure generally relates to systems and methods for digital imaging. In particular, the present disclosure relates to mobile capture experience for rides.

### Description of the Related Art

With the widespread use of mobile devices, users are able to document their own experiences using video and/or audio recordings. In this way, users are able to save the experience for future reference.

There are scenarios, however, where users are not permitted to use their mobile devices to document their experience. One such scenario involves carnival-type rides (e.g. rollercoasters) where safety concerns limit when users are able to use their mobile device. Furthermore, there is a possibility that the user loses the mobile device while trying to document their experience while the ride is in motion.

Although some rides may incorporate imaging, video and/or audio recordings, such implementations are generally not specific to a particular user. Rather, the image, video and/or audio encompass the various other riders on the same ride. Furthermore, after completion of the ride, the ability for the user to acquire the images, video and/or audio may be cumbersome.

There is a need to allow users to document/record their own experiences via images, video and/or audio on a ride. Furthermore, a more efficient means of providing such documentation of the user's experience on the ride is also needed so that users would not need to wait.

### SUMMARY

Embodiments of the present disclosure include systems and methods directed towards automatically documenting a user's experience on a ride. A user device implementing such a method may transmit user information to a capture and distribution system, which may then uniquely identify the user in one or more recordings during a ride. Such a user device may further include an application that facilitates receiving user input that includes requests for recordings and modifications to existing recordings. A plurality of sensor devices may be associated with the ride and may be used to capture images and other information regarding the user experience on that ride in a recording. Such a recording may be further tagged to indicate which user(s) are identified as present within the recording. Such tags, which may be used to organize or search for recordings, can be stored in memory. Various modifications may further be made to the tagged recording based on the user information, as well as stored alongside unmodified tagged recordings in memory.

### BRIEF DESCRIPTION OF THE DRAWINGS

FIG. 1 illustrates a system for implementing mobile capture experience for rides.

FIG. 2 is an example image capture performed by the automated image capture and distribution system.

FIG. 3 illustrates a method performed by the guest detection software.

FIG. 4 illustrates a method performed by the image enhancement software.

FIG. 5 illustrates a method performed by the distribution software.

FIG. 6 illustrates a method performed by the guest content software.

FIG. 7 illustrates example graphical user interfaces (GUI) associated with the application on the user device for communicating with the automated image capture and distribution system.

FIG. 8 illustrates an example tagged database.

FIG. 9 illustrates an example guest database.

FIG. 10 is a block diagram of an exemplary computing device that may be used to implement an embodiment of the present disclosure.

FIG. 11 illustrates a system for implementing mobile capture experience for rides in accordance with another embodiment of the present disclosure.

FIG. 12 shows the user information database in accordance with another embodiment of the present disclosure.

FIG. 13 shows an exemplary diagram of controlling permission accordance with another embodiment of the present disclosure.

FIG. 14 shows an exemplary timeline accordance with another embodiment of the present disclosure.

FIG. 15 shows an exemplary system overview accordance with another embodiment of the present disclosure.

### DETAILED DESCRIPTION

The present application describes systems and methods for implementing ways for users to link their mobile devices wirelessly to a capture and distribution system associated with a ride (i.e. roller coaster). The capture and distribution system would be used to facilitate documentation of the user's experience on that ride via pictures, video and/or audio recordings. The capture and distribution system may be set up so as to provide a personal documentation of each user's experience. For example, each rider may be provided their own set of cameras and microphones used to obtain pictures, video and/or audio recordings specific to that user.

In this way, the capture and distribution system would allow the user to enjoy the experience of the ride instead of requiring the user to document their experience using their own mobile phone. The self-documentation of the user's experience while the ride is in motion may pose a safety issue to the user or others in the ride. In situations where the ride is a rollercoaster, the user's arms may be required to be within a particular vicinity. If the user extends their arms outside the vicinity to take a self, for example, this may pose a safety concern to the user as well as to others within the same ride.

Furthermore, the self-documentation through the use of the user's mobile device while the ride is in motion can also raise the risk of loss or damage to the mobile phone. Many times the mobile device can be an expensive piece of property of the user. When the ride is in motion, there is a possibility that the user loses control of the mobile phone. Alternatively, the user may come into contact with surrounding objects that may damage or knock the mobile device from the user's control.

After the ride has been completed, the capture and distribution system can provide the pictures, video and/or audio recordings wirelessly to the user's mobile device. In some situations, the recordings may be provided automatically. In other situations, some monetary transactions between the user and the capture and distribution system may be needed before the recordings are transmitted to the user. There is also a possible further embodiment where additional features (e.g. photo enhancements) are implemented with respect to the recordings.

The present application would provide many benefits. First, users would be able to enjoy the experience of the ride without being preoccupied with documenting the experience as well as removes distractions that this may cause to other users riding the same ride. Furthermore, the present application would allow users to receive the recordings (e.g. photo, video, audio) more efficiently after the ride has been completed.

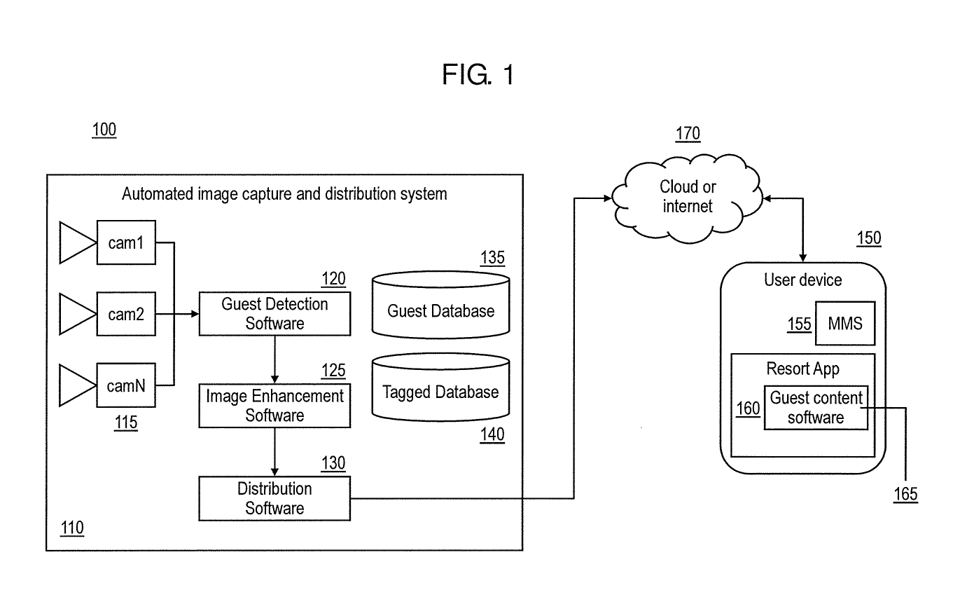

FIG. 1 illustrates a system 100 for implementing mobile capture experience for rides. It should be noted that the system 100 illustrated in FIG. 1 is an example and that other arrangements are also possible.

The system 100 includes a variety of different components. The system 100, as illustrated in FIG. 1, includes an automated image capture and distribution system 110, the user device 150, and a network 170. The automated image capture and distribution system 110 is designed to document the user's experience on a ride. The automated image capture and distribution system 110 may be associated with a particular ride. The user device 150 can be, for example, a mobile device that is used to communicate with the automated image capture and distribution system 110. The network (i.e. cloud or internet) 170 facilitates the communication between the automated image capture and distribution system 110 and the user device 150. Additional details regarding the automated image capture and distribution system 110, the user device 150 and the network 170 will be provided below.

As illustrated in the figure, the automated image capture and distribution system 110 includes a plurality of different cameras 115 that would be capable of capturing image data of one or more users on a particular ride. The different cameras 115 may each be positioned on the ride so as to capture a personal experience for each user on the same ride. In this way, each rider may be provided their own camera to capture, for example, a facial reaction during the ride. In another scenario, the different cameras 115 may be positioned so as to capture the overall experience of all the users on the same ride but from different perspectives. In a further embodiment, the different cameras 115 may be mobile whereby the cameras 115 may be repositioned to obtain different perspectives of the user during the ride. The repositioning of the mobile cameras 115 may be performed by the user, an administrator overseeing the ride or automatically via the guest detection software 120. Further embodiments may also allow users to select between various types of camera of different styles and quality.

Although not included in the figure, each of the different cameras 115 may also be associated with microphones or other devices that can be used to capture and record data associated with the user's experience on the ride. The microphones may be usable to record the user's verbal reactions (e.g. screams, gasps) during the duration of the ride. Other devices (e.g. biometric-related) may be capable of capturing and recording other data (e.g. heart-rate) that can be also associated with the recording of the user's experience on the ride.

The automated image capture and distribution system 110 also includes guest detection software 120. The guest detection software 120 would be associated with various sensors or devices (e.g. motion sensor, pressure plate) that can be used to indicate to one or more cameras 115 when images, video and/or audio should be captured. In another embodiment, the guest detection software 120 may receive an input from a button or trigger to indicate to one or more cameras 115 when images, video and/or audio should be captured. In a further embodiment, the guest detection software 120 may provide automated instructions to the cameras 115 to capture images, video and/or audio at regular time intervals or to continuous record for a period of time.

The guest detection software 120 may also include instruction describing how the cameras 115 should capture images, video and/or audio of the user during the ride. For example, the guest detection software 120 may include instructions for the cameras 115 in situations where the cameras 115 are mobile. At particular pre-determined portions of the ride, the cameras 115 may be instructed to move to particular locations in order to record an expected reaction from the user. The guest detection software 120 may also communicate with the image enhancement software 125 (described below) to dictate how the captured image, video and/or audio can be modified.

The guest detection software 120 may also be instructed to use various methods or algorithms to identify users captured in the images, video and/or audio recordings. For example, using information from the guest database 135, facial recognition and voice recognition information may be used to match the identity of the user from the guest database 135 with the user(s) within the images, video and/or audio recordings. In another embodiment barcodes or QR codes associated with the user (i.e. affixed to a sticker, lanyard, hat, temporary tattoo) can be used to identify users within the images and/or video recording against user information stored within the guest database 135 where the associated barcode or QR code associated with that particular user is stored. The guest database 135 may also include previously stored audio recording of the user's voice identifying who they are. The guest detection software 120 may compare audio recordings with the previously stored audio recordings in the guest database 135 to identify which users are present in the audio recording.

It should be noted that other methods of identifying users within an image, video and/or audio recording can also be implemented aside from what is described above. For example, users may be provided with transmitters (e.g. RFID) that can be used to identify individual users. A sensor associated with the guest detection software 120 can identify what transmitter signals are detected on a ride and tag the recording accordingly.

By using the identification of the user within the recordings, the images, video and/or audio recordings may be labeled or tagged accordingly with the assistance of the guest detection software 120 with the identity of the user(s) present within the recording. Furthermore, the tags may be used by the distribution software 130 to identify where the recordings may be transmitted to (e.g. a particular user's user device 150).

The image enhancement software 125 included in the automated image capture and distribution system 110 provides functionality associated with modifying image, video and/or audio recordings. The recordings may be modified based on user request. In some embodiments, a subscription may be required before users are allowed to modify various recordings.

The image enhancement software 125 may communicate with the tagged database 140 in order to retrieve corresponding recordings associated with the user. The image enhancement software 125 may also communicate with the guest database 135 in order to retrieve any modification preferences associated with the user.

The image enhancement software 125 may implement any number of possible image, video and/or audio modifications known in the art to the tagged recordings. For example, the image enhancement software 125 may have associated various tools that allows the recordings, specifically image and/or video, to be in any number of different ways such as altering brightness, contrast, color correction, implementing black/white, removing red-eye, adding text overlays, watermarking, cropping, resizing, stretching, transforming, incorporating novelty filters or decorations, posterization, inverting colors, incorporating motion blur, sharping details, and “face-swap” functionality. With respect to audio recordings, the modifications may include altering volume levels and adding background music or sound effects.

The modified recording is also stored in the tagged database 140 alongside the original recording. In this way the user is able to view and/or download both the original and the modified recordings to their user device 150. The modified recording would include the same user tags as the original recording so that the automated image capture and distribution system 110 would be able to search for and transmit the requested recordings to the users as needed. Furthermore, if the original recording is removed from the tagged database 140 (e.g. after an expiration time), the corresponding modified recording can also be removed at the same time.

The distribution software 130 facilitates the transmission of recordings stored with the automated image capture and distribution system to corresponding user devices. In particular, the distribution software 130 retrieves tagged recordings (original and modified) and transmits the retrieved recordings to the appropriate user device. The transmission may utilize any available network (e.g. Internet, cloud, Wi-Fi).

Determination as to which user device should be sent a particular recording can be carried out using the guest database 135. In some embodiments, the guest database may include information (e.g. identification) about the corresponding user device 150 for a user. Such identification may include a unique identification associated with the application 160 used by the user on the user device 150 to communicate with the automated image capture and distribution system 110. In this way, the distribution software 130 can search for and identify the appropriate user device to transmit the recordings based on a received request for the recordings coming from the user.

The guest database 135 includes information used to identify each individual user. The information may be used to identify a particular user on a ride. Such information may be compiled from each user as they are entering the premises (e.g. theme park) where the ride(s) are located. For example, the user may need to “check in” at the entrance. “Check in” may involve taking a photo of the user or assignment of a barcode/QR code. The user may also provide an audio recording.

As described above, the guest database 135 information may be used to identify users within a particular image, video and/or audio recording taken by the automated image capture and distribution system 110.

The guest database 135 may also include an indication whether the user is authorized to view, modify and/or purchase the image, video and/or audio recordings captured by the automated image capture and distribution system 110. In some cases, authorization may be provided for free with paid admission to the premises (i.e. theme park).

In some situations, the authorization may require a monetary transaction. For example, the user may be allowed unlimited viewing, modification and downloading of the recordings after paying an associated fee for the service. In other situations, the user may be required to pay a fee for each viewing, modification and download of the recording from a ride.

The tagged database 140 is used to store the image, video and/or audio recordings of the users on the ride obtained by the automated image capture and distribution system 110. The tagged database 140 may organize the stored recordings based on the user(s) tagged to each recording. In this way, when a user wishes to view, modify and/or download their recording for a ride, the tagged database 140 can search for and provide the appropriate recording. Furthermore, the recordings may be tagged based on which ride the recording is associated with as well as when the recording was obtained (i.e. time stamped).

The tagged database 140 may temporarily store the captured recordings until the recordings have been transmitted to the corresponding users. In another embodiment, the tagged database 140 may place an expiration timer (e.g. 1 hour) on each recording stored in the tagged database 140 based on when the recording was first stored in the tagged database 140. After the expiration time period has been exceeded, the corresponding recording can be removed from the tagged database 140. Furthermore, after a period of time it may be presumed that users would have no interest in viewing, modifying and/or downloading the recording. This can ensure that the tagged database 140 does not become overburdened with storing unneeded recordings 140 and ensure that there is sufficient space for new recordings.

The user device 150 may be any number of different computing devices. Although the embodiments described herein reference the user device being a mobile device (i.e. smartphone), it should be noted that other devices such as tablets and laptops are also possible.

The user device 150 may include a multimedia messaging service (MMS) 155 or application 160 used to communicate with the automated image capture and distribution system 110. The user may be able to provide an indication as to which rides the user the user would like to obtain recordings for before riding the ride. The user may also be able to select, using the MMS 155 or application 160, what type of recordings should be obtained and how the recordings should be obtained (i.e. positioning of the camera).

The MMS 155 or application 160 may also allow the user to view, download or modify the image, video and/or audio recordings from the automated image capture and distribution system 110. The user may be able to provide user preferences associated with the recordings and/or distribution preferences (i.e. automated download/viewing of all available recordings, use of certain modifications to the recordings).

In situations where payment is required before the user is able to view, download or modify recordings, the MSS 155 or application 160 can facilitate payment from the user to the corresponding entity associated with the automated image capture and distribution system 110.

The application 160 may include guest content software 165. The guest content software 165 may include information used to uniquely identify the user device 150 and/or application 160 so that the automated image capture and distribution system 110 can identify who is sending recording requests and where the recordings should be transmitted to. Information about the user device 150 and/or application 160 associated with the guest content software 165 may be stored within the guest database 135. For example, upon entry to the premises (e.g. theme park) or when the user is near a particular ride associated with the automated image capture and distribution system 110, the information about the user can be provided to the system 110 by the guest content software 165 automatically. Alternatively, the user may be notified that user information may be needed in which at this point the user can use the application 160 to transmit relevant user information via the guest content software 165.

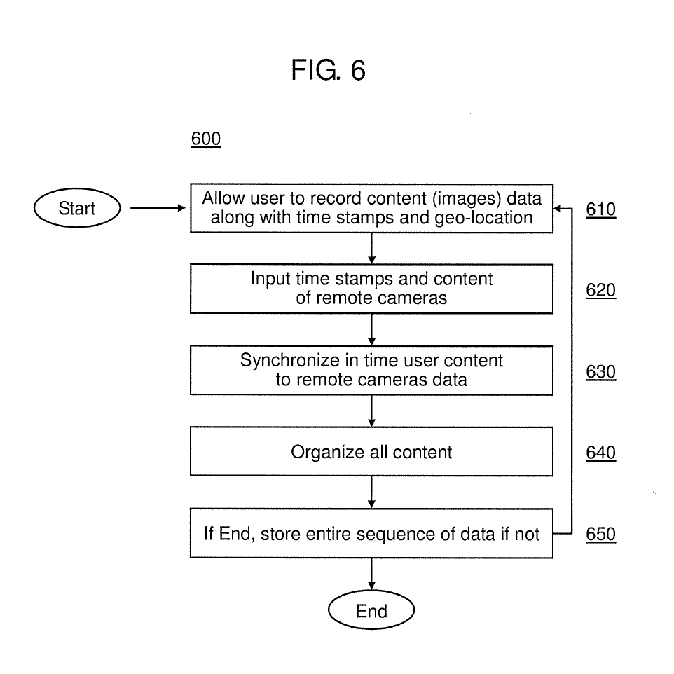

Furthermore, the guest content software 165 can also be used to communicate with the automated image capture and distribution system 110 to dictate whether any image, video and/or audio recordings should be obtained for the user as well as request the recordings from the system 110 to be transmitted to the user device 150 when available. Further details regarding these functionalities of the guest content software 165 is provided below with respect to FIG. 6.

The transfer of info nation between the automated image capture and distribution system 110 and the user device 150 is performed over a network 170. Generally, the network may be the cloud or internet. It should be noted that communication between the system 110 and the user device 150 may also be carried out using other methods including Wi-Fi, Bluetooth, and RFID.

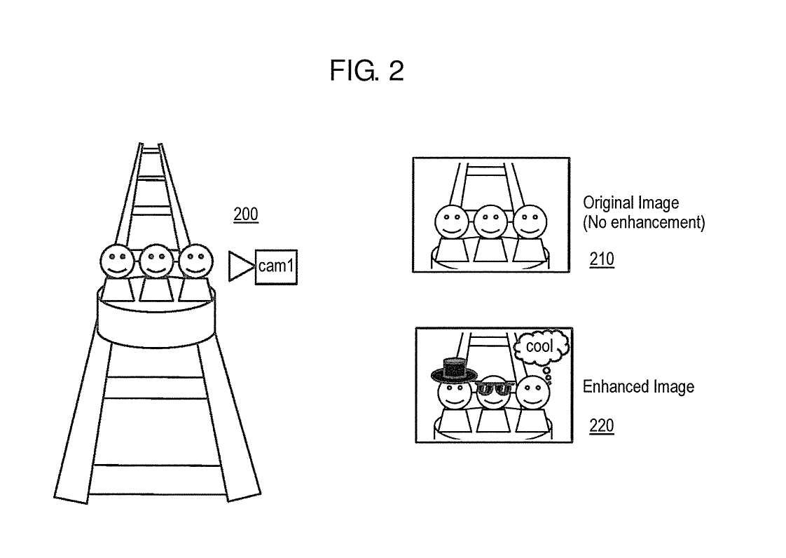

FIG. 2 is an example image capture performed by the automated image capture and distribution system. The automated image capture and distribution system as illustrated in FIG. 1 may be associated with a ride where three users are being recorded while on a ride 200. At least with reference to FIG. 2, the three users have their image recorded using a camera. It should be noted that other embodiments may include multiple cameras and/or microphones and that video and/or audio may also be recorded while the three users are on the ride. Furthermore, the modifications that are described below with respect to the images as illustrated in the figure may similarly be applicable to video and/or audio recordings.

The automated image capture and distribution system of FIG. 1 may obtain and store an image recording initially with no enhancements 210. As noted above, the original image may also include one or more tags of the users included in the image.

Furthermore, enhancements can also be incorporated with the image of the three users on the ride 220. The enhancements may be specific to the theme of the ride. In other embodiments, the enhancements may be inclusive of any known enhancements in the art. For example, users may be able to modify the image using enhancements where different decorations or filters are added.

It may also be possible that enhancements are automatically performed by the automated image capture and distribution system. For example, themed enhancements associated with the ride may be applied to the image. The user may be allowed to view the proposed modifications to the image and subsequently accept, deny or modify aspects of the enhancements.

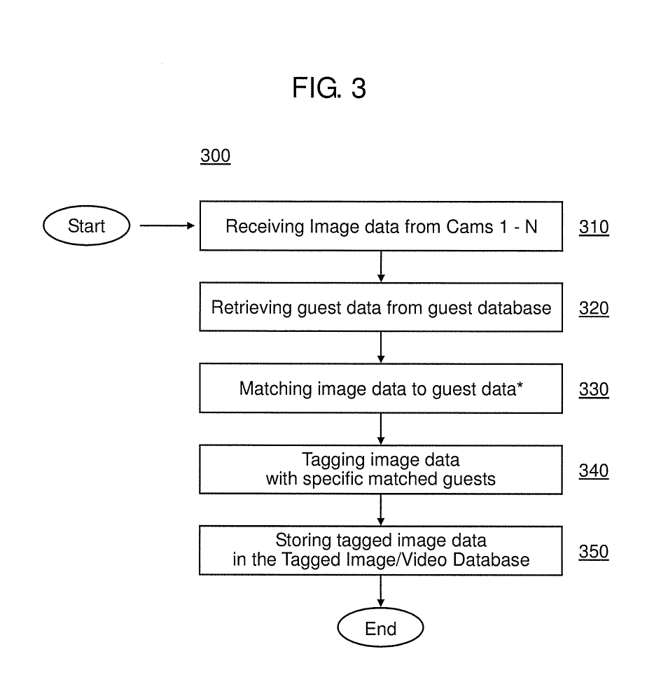

FIG. 3 illustrates the method performed by the guest detection software 300. As described above, the guest detection software can be used to control the one or more cameras and/or microphones associated with the ride regarding the image, video and/or audio recordings that are captured. Furthermore, the guest detection software can be used to identify user(s) within the recordings.

In step 310, the guest detection software receives data from the plurality of cameras associated with the ride. As noted above, there may also be microphones associated with the ride so that audio can also be recorded aside from image and/or video. Although the guest detection software may include instructions used to instruct when the cameras and/or microphones should record images, video and/or audio, there may be embodiments where the cameras and/or microphones are constantly recording and the software may request data associated with a particular user or ride.

In step 320, the guest detection software retrieves guest data from the guest database. The guest detection software may be able to identify users within the image, video and/or audio data received from the cameras and/or microphones in step 310. As described above, the user may be identifiable a variety of different ways including via QR code or barcode associated with the user, via facial recognition, voice recognition or transmitted signal detected on the ride. Using the identification of possible users from the recording, the guest detection software can search through the guest database to find one or more user profiles that may closely match what was obtained.

In step 330, the guest detection software confirms the match between user(s) associated with the image, video and/or audio recording associated with the ride with the corresponding user information stored in the guest database. Using the matched information, the recording can be tagged with information linking that the user is associated with that recording (in step 340). In this way, the user would be able to search for all recordings associated with the user. The tags would also allow the automated image capture and distribution system of FIG. 1 to search for and provide associated recordings for each user requesting recording data.

After the recordings are tagged with user information, the tagged recordings are stored in the tagged database in step 350. The tagged database 350 may store and organize the recordings based on ride or by user. Furthermore, the tagged database 350 may also include an expiration condition so that stored recordings can be removed from the tagged database 350 after a pre-determined period of time.

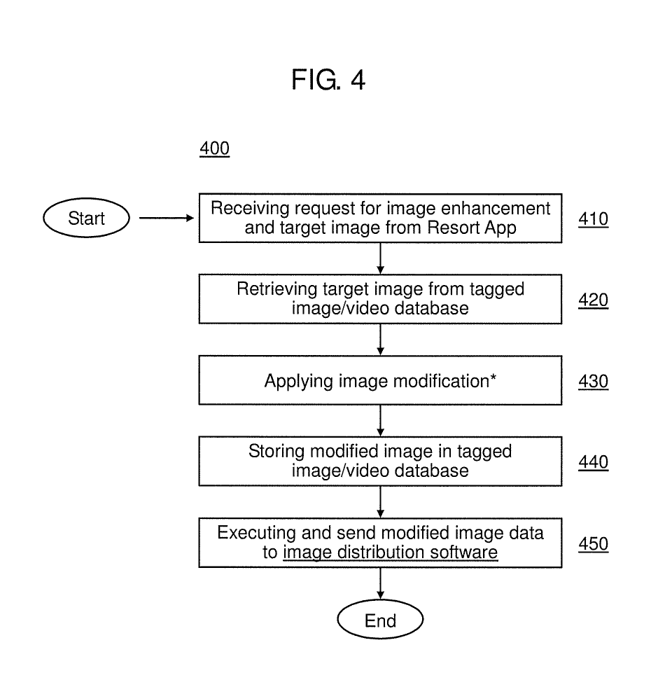

FIG. 4 illustrates a method 400 performed by the image enhancement software. As described above, the image enhancement software provides functionality to the automated image capture and distribution system so that users are able to modify captured images, video and/or audio recordings. The recordings may be modified based on user request or automatically by the system. The modifications may be themed specific to the ride associated with the recording or include modifications presently used in the art. Furthermore, the user's ability to modify the images, video and/or audio recordings may be associated with payment of one or more fees.

In step 410, the image enhancement software may receive a request for enhancements from the user via an application on the user device. The request for enhancements may identify the particular image, video and/or audio recording to be enhanced. Furthermore, the request may include details regarding how the enhancements should be carried out. For example, the user may provide details regarding what modifications should be performed and how they should be applied. In other scenarios, the user may wish that the image enhancement software perform a plurality of different modifications randomly themed specific to the ride associated with the image, video and/or audio recording.

As described above, modifications for images and/or video recordings may include altering brightness, contrast, color correction, implementing black/white, removing red-eye, adding text overlays, watermarking, cropping, resizing, stretching, transforming, incorporating novelty filters or decorations, posterization, inverting colors, incorporating motion blur, sharping details, and “face-swap” functionality. With respect to audio recordings, modifications may include altering volume levels and adding background music or sound effects.

In step 420, the image enhancement software retrieves the particular image, video and/or audio recording subject to the request from the tagged database. The retrieval may use the tagged information associated with the user requesting the enhancement. In some embodiments, the user (via the application on the user device) may provide information identifying the particular image, video and/or audio recording. For example, each stored recording may include (in addition to the tagged user information) a corresponding ride and serial identification number used to uniquely identify each recording.

In step 430, modifications may be applied to the image, video and/or audio recording. The modifications may be based on user input dictating what type of modification should be applied and how they should be applied. In some scenarios, the modifications may be proposed by the image enhancement software but only applied when confirmed by the user via the application on the user device.

In step 440, the modified recordings are stored in the tagged database. The modified image, video and/or audio recordings may be stored alongside the original recording. Furthermore, the modified recordings may utilize the same tagged information so that both the modified recording and the original recording can be searched for and provided to the user using the same search terms (e.g. user identification, ride, time).

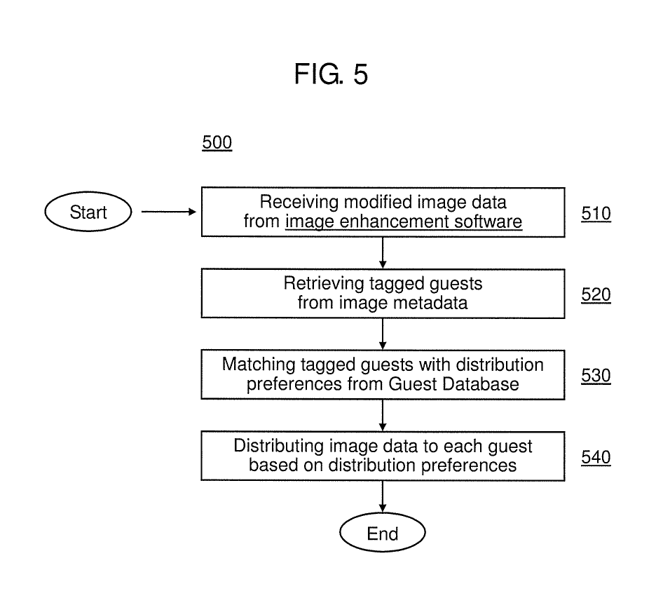

In step 450, the modified recording (as well as the original) can be provided to the distribution software. The distribution software can utilize the information associated with the guest database to determine where the recording should be transmitted. Further details regarding the distribution software will be provided below with respect to FIG. 5.

FIG. 5 illustrates a method 500 performed by the distribution software. As described above, the distribution software controls how the image, video and/or audio recordings are transmitted from the automated image capture and distribution system to the corresponding users. The recordings may be received from the image enhancement software (as described above in FIG. 4) after the recordings has been modified. Alternatively, a user request for a particular recording may have the recording retrieved from the tagged database and provided to the distribution software for transmission to the user.

In step 510, the recording data (original and/or modified) may be provided to the distribution software. The distribution software can receive recordings from a variety of different sources. For example, the image enhancement software may provide modified recordings after a modification has been implemented. In another situation, recordings can be provided from the tagged database upon request from the user. In another scenario, the guest detection software may provide the distribution software the recording directly from the cameras and/or microphone after the ride has been completed.

In step 520, the distribution software can retrieved tagged information for users associated with the received recording. The tagged information may include the identity of users who are found within the recording. As noted above, the users may be tagged using facial recognition and/or barcodes or QR codes associated to the captured user.

In step 530, the distribution software matches the tagged users associated with recordings in order to identify where the recordings should be transmitted. For example, the guest database may include information for each tagged user identifying the application and/or user device the recording should be transmitted to.

Furthermore, the guest database may include information regarding whether the user has paid for access (viewing or downloading) to the recording. Absent indication of payment for the services associated with the automated image capture and distribution system, the distribution software can prevent transmission of the recording to particular users.

In step 540, the recordings can be transmitted to each user based on distribution preferences. For example, the transmission of the recordings to the user can be performed automatically once the recordings are available. For example, once a ride has been completed, any modified or original image, voice and/or audio recordings can be provided to the user device(s) associated to the users within the recording.

In other embodiments, the distribution software may need to receive confirmation of user payment before transmission of the recordings can be carried out. This corresponds to scenarios where an entity associated with the automated image capture and distribution system would like to monetize and charge users for use of the service. In these situations where the user is required to pay for access to the recordings, the distribution software will search for/poll for the required indication (e.g. payment confirmation from the automated image capture and distribution system) before transmitting the recordings to the corresponding user device.

FIG. 6 illustrates a method 600 performed by the guest content software. As described above, the guest content software associated with the user device can be used by the user to communicate with the automated image capture and distribution system. The communication may include indicating when recordings should be obtained for the user on particular rides and acquiring those recordings from the automated image capture and distribution system when available.

In step 610, the guest content software may provide an indication that the automated image capture and distribution system should record images, video and/or audio of the user experience on a particular ride. The guest content software can identify what type of recording is desired by the user. Furthermore, additional information may also be added to the recordings based on the user's preference. For example, the user may wish to have additional information such as time-stamps (e.g. date and time) and geolocation information (e.g. name of the ride) appear on the image and/or video recording.

In step 620, the guest content software may provide this additional information (e.g. time stamps) to the automated image capture and distribution system to be implemented in the recordings. In this way, the user can control what types of additional information is added to the image, video and/or audio recordings obtained by the automated image capture and distribution system.

In step 630, the guest content software can synchronize the user added content with the recordings being obtained from the automated image capture and distribution system. It may be possible, in an embodiment, that the recording information is transmitted directly to the user as soon as it is recorded via the cameras and/or microphones associated with the automated image capture and distribution system. In this way, the user device may be able to receive a “live stream” of the user experience. Therefore, the guest content software would need to synchronize the information being transmitted to the user device with the additional information (e.g. time stamps, geolocation information) that the user would like to add to the recordings.

In step 640, the guest content software would then organize the recordings. The organization may be performed based on tagged information associated with the recording. For example, the recordings can be tagged based on who appears within the image and/or video recording, when the recording was obtained, or where the recording was taken. In this way, the user would be able to search for particular recordings (or portions of a recording) in the future based on the organization implemented by the guest content software.

In step 650, the guest content software may continually be performing steps 610-640 as recording information is transmitted in real time from the automated image capture and distribution system to the user device. The guest content software may be receiving the information and simultaneously adding the time stamps and other information. Once the recording has been completely transmitted to the user device, the guest content software can confirm that no additional information will be transmitted from the automated image capture and distribution system and safely terminate.

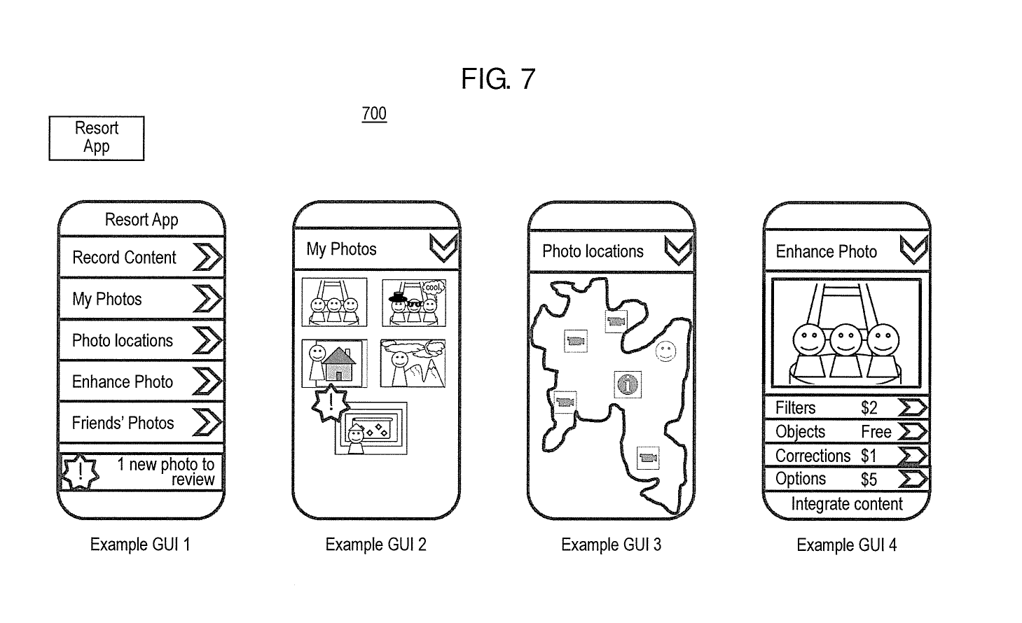

FIG. 7 illustrates example graphical user interfaces (GUI) 700 associated with the application on the user device for communicating with the automated image capture and distribution system. Example GUI 1 illustrates an example home-screen view with various options. For example, these options may include 1) record content, 2) my photos, 3) photo locations, 4) enhance photos, 5) friend's photos, and 6) notifications.

The ‘record content option’ may be used by the user to indicate (through the application) that the user would like the automated image capture and distribution system to obtain recordings of the user on a particular ride. The user may indicate that recordings should be obtained for particular rides or for all rides.

The ‘my photos’ option may be used to view recordings that are currently stored on the automated image capture and distribution system or on the user device itself. Similarly, the ‘friend's photo’ option allows users to view recordings that are currently stored on the automated image capture and distribution system associated with one or more linked friends. Selection of ‘my photos’ or related friend name can provide the user identification from the user device to be matched with tagged recordings stored in the tagged database.

Selection of friend's photo may require that the friend provide authorization for others to view recordings. This authorization may be presumed if the friend appears on the user's possible list of friends. The application may allow the user to send friend requests to other users also using the application. If accepted by the others, the new friend will appear on the friend list that allows the user to select and view recordings associated to that user. The other users (i.e. friends) may also have the ability to control what recordings are available for the user to view using the “friends' photo” option. For example, the friend's photos may be only viewable after the friend has authorized the sharing of such recordings.

The ‘photo locations’ option may be used to identify what rides nearby the user are compatible with the automated image capture and distribution system. In this way, the user can be informed what rides can record the user experience automatically using the automated image capture and distribution system.

The ‘enhance photos’ option allows the users to dictate whether modifications can be performed on the recordings by the automated image capture and distribution system. Furthermore, the ‘enhance photos’ option may also allow the user to customize how the modifications can be performed.

Lastly, the ‘notifications’ can provide information to the user regarding the availability of recordings belonging to the user and/or other users on the friends list. The notification can also provide information regarding when recordings were made available and when recordings may expire (i.e. become deleted).

Example GUI 2-4 provide example illustrations of the ‘my photos’, ‘photo locations’, and ‘enhance photo’ functionalities associated with the application described above. With respect to the example GUI 2, the ‘my photos’ my provide thumbnails for each available recording. Furthermore, an indication may be provided for newer recordings that the user has not yet viewed. Once a thumbnail is selected, the application may allow the user to view a full-screen image and/or video recording as obtained from the automated image capture and distribution system.

With respect to example GUI 3, a map of the premises (e.g. theme park) can be provided with various symbols associated with various rides illustrating where the automated image capture and distribution system may be compatible. The user may be able to indicate where the user would like recordings to be taken by selecting one or more symbols associated with that particular ride. In some embodiments, these symbols may also be selectable to download the corresponding recording for the user (if available).

Lastly with respect to GUI 4, an example enhance photo functionality is illustrated. The user is able to utilize various modification features ranging from using filters and adding objections to existing recordings. These modification features may be free or may require payment of a fee to be used. Once inputted, the user can select the ‘integrate content’ feature to upload the proposed modifications to the automated image capture and distribution system. The image enhancement software can then incorporate the proposed modifications to the recording stored in the tagged database. The modified recording can also be stored in the tagged database. The user can, at a later time, request to view and/or download the original recording and the modified recording from the automated image capture and distribution system.

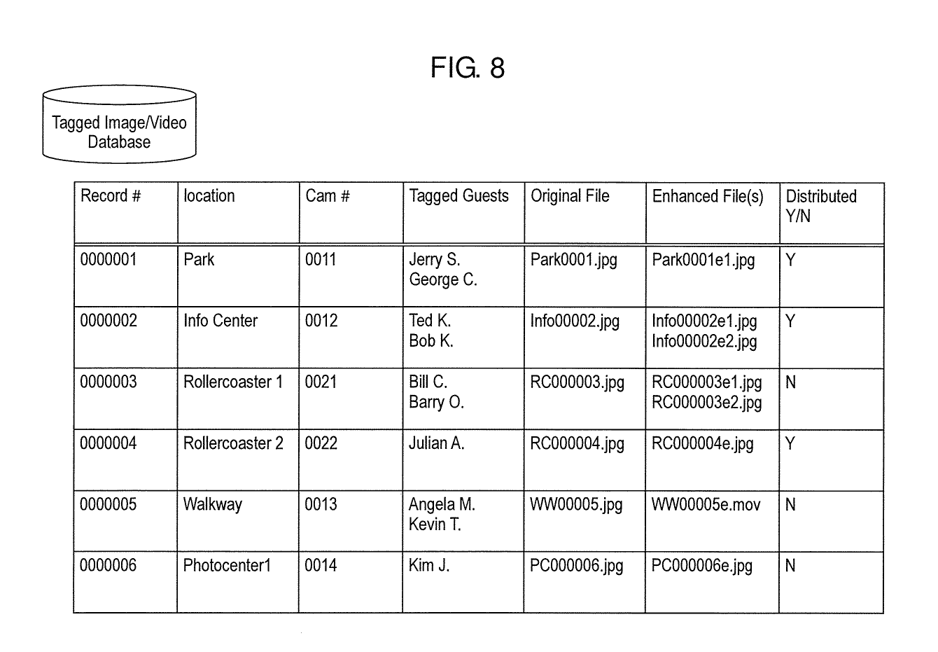

FIG. 8 illustrates an example tagged database. The tagged database includes a record of each recording obtained using the automated image capture and distribution system. The recordings may be organized using information such as a record number, a location of where the image, video and/or audio recording as taken, identification of the device (e.g. camera, microphone) that was used to capture the recording, the identity of one or more users present in the recording, recording file name, associated modified file name, and whether the recording has been provided to the user.

As noted above, additional information may also be included in the tagged database. For example, an expiration timer may be included so that the automated image capture and distribution system may know when to delete older recordings from the tagged database.

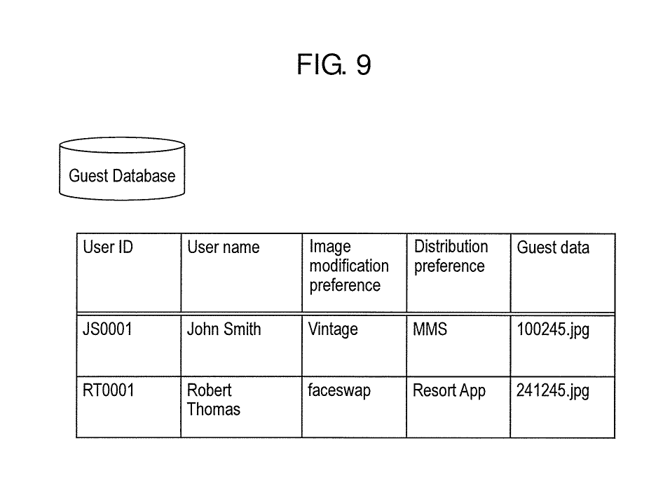

FIG. 9 illustrates an example guest database. The guest database is used to store information about each user that may request recordings from the automated image capture and distribution system. The information within the guest database includes, for example, the user identification, user name, image modification preference, and other related guest data that can be used to identify the user. Such additional information may include identification for the user's user device and/or account profile associated with the application used to communicate with the automated image capture and distribution system.

The information stored in the guest database may be provided by the user using the application on the user device. For example, upon entry of the premises (e.g. theme park), the application may communicate with the automated image capture and distribution system to provide user information used to populate the guest database. The user may also be prompted on the application to upload their info to the guest database of the automated image capture and distribution system in order to use the image capture functionalities described above.

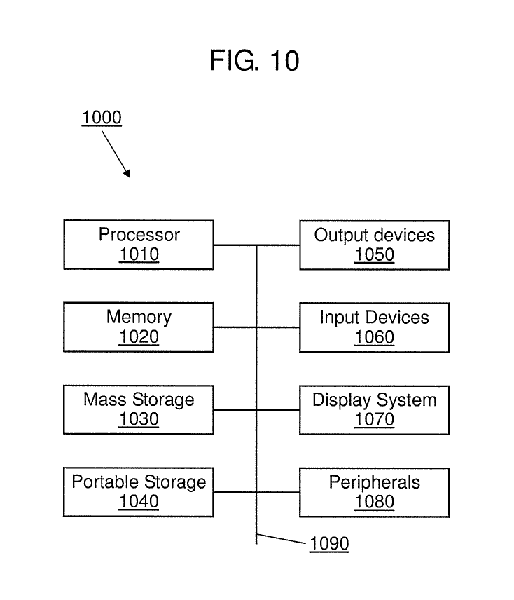

FIG. 10 illustrates an exemplary computing system 1000 that may be used to implement an embodiment of the present invention. The computing system 1000 of FIG. 10 includes one or more processors 1010 and memory 1020. Main memory 1020 stores, in part, instructions and data for execution by processor 1010. Main memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1020.

Portable storage device 1040 operates in conjunction with a portable nonvolatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD) or other suitable display device. Display system 1070 receives textual and graphical information, and processes the information for output to the display device.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

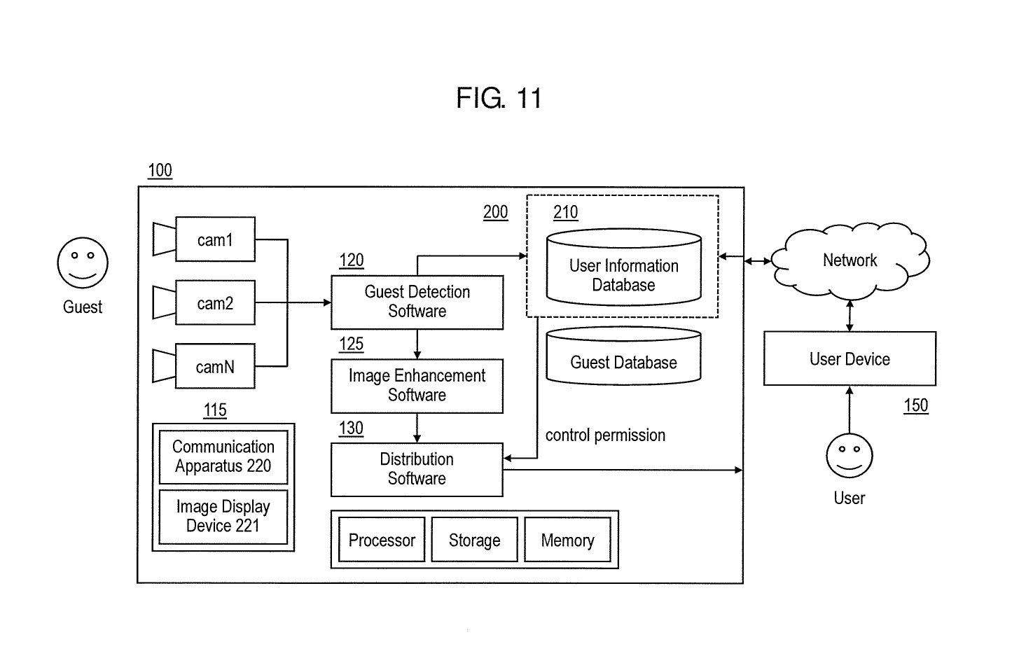

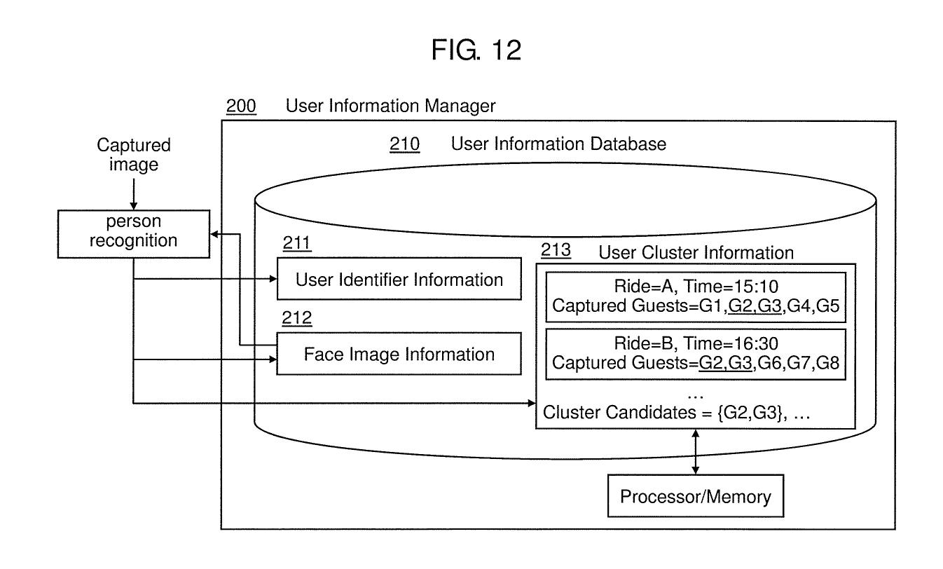

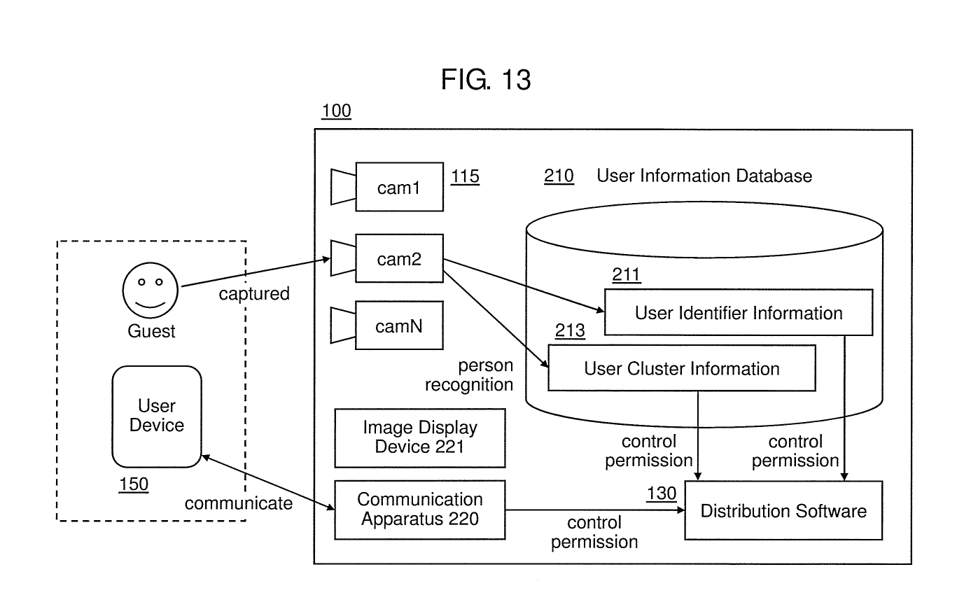

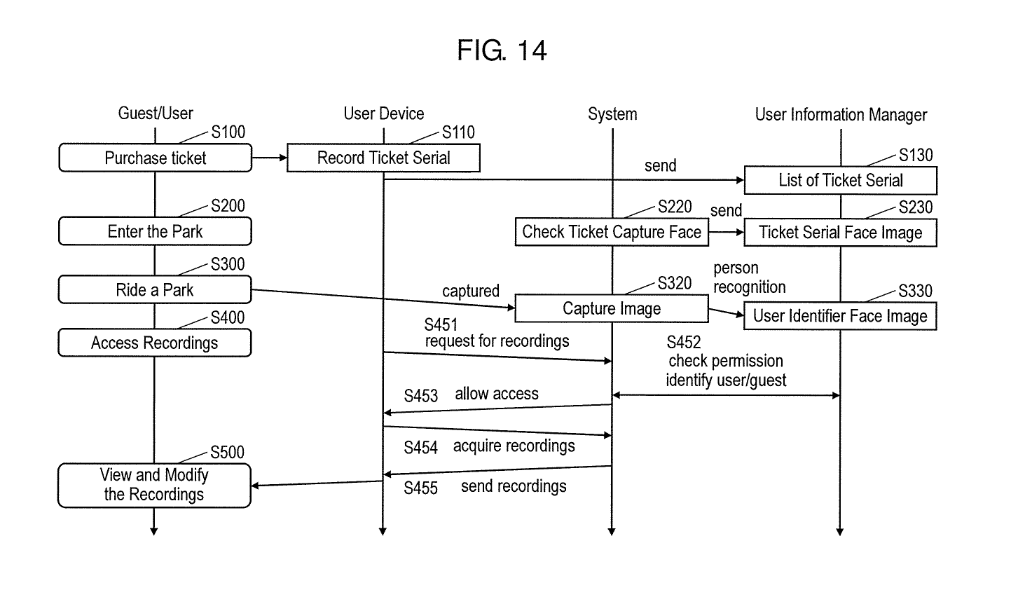

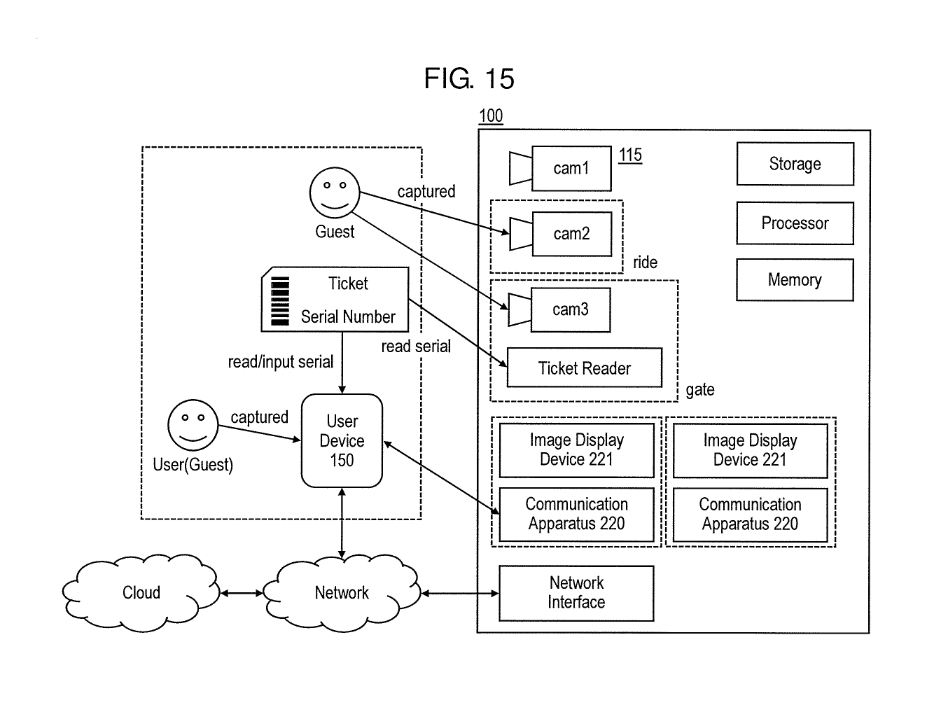

FIGS. 11-15 show one or more other configurations of the present disclosure. Configurations, operations, method, processes, devices, hardware, and/or software explained with respect to FIGS. 1-10 may be employed to the following examples, and the detailed explanation thereof may be omitted. FIG. 11 shows an exemplary configuration of the system including the user information manager 200. FIG. 12 shows the user information database 210. FIG. 13 shows some examples of controlling permission. FIG. 14 shows a timeline. FIG. 15 shows a system overview.

The automated image capture and distribution system 100 in the configuration shown in FIG. 11 includes a user information manager 200. The user information manager 200 can be realized with a server, for example. It is noted that the server may or may not perform other functions. The implementation of the system 100 is not limited to a local service and/or a cloud service. The aforementioned (and the following) functions, operations, processes and/or method can be implemented by software (one or more programs). The software is stored by one or more storage devices, such as a read-only memory (ROM) including an optical disk (CD-ROM, DVD-ROM, etc.), a hard disk drive, a flash memory, a magnetic disk and a magnetic tape, and is executed by one or more processer together with one or more peripheral devices (e.g., an I/O circuit, a communication circuit, a display, and etc.) to realize the functions, operations, processes and/or method described in the present disclosure. In some embodiments, the software is stored in a memory and can be executed by a processor of the system 100. The software the system 100 can also be executed on a cloud service over the network.

Configurations shown in FIGS. 11-15 realize identifying a guest or a group of guests in a park and help user authentication for accessing recordings form a user device. The configurations allow the user to find recordings of the guest/group from thousands of the recordings of the park.

According to an exemplary configuration, the camera 115 (one of the plurality of devices) captures the guest who experiences the ride. Each of the guests in the captured image (recording) is identified by person recognition referring to user information. A user who requests to access the recording via a user device is identified and related to the user information. The user information correlates the user of the user device and the guest captured in the recording. Therefore, the captured image which is corresponding to the user is specified among thousands of the captured images.

When a guest enters a park (e.g., an amusement park), a ticket serial number and the face image of the guest are obtained, as user information, by the user information manager 200. The user information may be obtained by a user device 150 of the guest. For example, a camera equipped with the user device can take a photo of the ticket serial number and the face image of the guest. In some cases, the user device can perform an OCR (optical character recognition) operation to convert the ticket serial number image into numerical data.

The user information manager 200 receives and manages the user information from the user device. The user information manager 200 correlates (i) the received user information, (ii) the user who experiences the ride and (iii) the person in the captured image, captured by the camera 115. The user information manager 200 may employ a person (face) recognition technology based on the captured image data to identify a specific guest (user).

As shown in FIG. 12, the user information manager 200 includes a user information database 210 which stores user identifier information 211 which uniquely identifies the user, and at least one piece of face image information 212. The user information manager 200 detects whether the user is in the captured image or not based on the face image corresponding to the user.

As shown in FIG. 13, the automated image capture and distribution system 100 further includes a communication apparatus 220 for communicating with the user device 150. The communication apparatus 220 is, for example, a NFC communication terminal or a wireless access point. The NFC communication terminal can be a specific terminal of the image capture and distribution system. The wireless access point can be a ride specific access point or an access point of the intra-park network.

FIG. 14 shows an exemplary timeline of the automated image capture and distribution system 100 and a transaction for accessing the recordings from the user device 150. When a guest purchase a ticket (S100), the user information manager 200 records the guest with the purchased ticket serial number (S130). If the guest purchases a ticket using the user device 150, the information indicating the correspondence between the user device 150 and the guest is also recorded by the user information manager 200 and/or the user device 150. This information helps identification between the user (or the user device 150) and the guest (S110, S130). When a plurality of tickets are purchased by one user, the user information manager records the plurality of tickets as a set of guests. The one user can be identified using a credit card number used in the purchase, information of the user device and/or the transaction which a plurality of tickets are purchased. The user cluster information 213 may include information with respect to the set of guest.

When the guest enters the park (S200), the ticket for the guest is checked at the gate of the park (S220). A gate camera at the gate may also capture face of the guest (S220). The user information manager 200 manages the guest information, the ticket serial and the face image (S230). The ticket serial and the face image are assumed to correspond to the guest.

When the guest rides a ride (S300) under the automated image capture and distribution system 100, camera 115 of the ride captures one or more images (S320). Person recognition identifies guests on the ride in the image. The timing when the guest passes the gate of the ride and the user cluster information 213 improve the accuracy of guest identification from the image. The user information manager 200 manages the user/guest identifier, the face image, the captured image and the user cluster information (S330). The face image information 212 can manage two or more face images for one guest to improve person recognition. The face image can include features of dresses and ornaments of the guest. The information also improves the accuracy of the person recognition.

When the user of the user device 150 requests for accessing recordings (S400), the user device 150 sends a request for recordings to the system (S451). The system checks permission of the user or the user device 150 by identifying the user and the guest referring to the user information manager 200 (S452). Whether the user device communicate via the communication apparatus 220 or via an open network outside the park is also checked (S452). When permission for some recordings, corresponding to the guest or a group including the guest, is granted to the user, the system sends a reply of access allowance to the user device 150 (S453). The user device 150 sends a request of acquiring recordings to the system (S454). The system sends recordings based on type of permission (S455).

Regarding step S400, the user device 150 sends user information with the request for recordings. The user information is used for identifying the guest. The user information includes a ticket serial number, a credit card number, a face image captured by the user device 150 and/or specific user identifier information. The ticket serial number can be acquired by inputting the serial number by the user, by acquiring ticket purchase history of the user device or by imaging and recognizing an captured image of the ticket. The face image, captured by built-in camera of the user device 150, can be used with other information which indicates the guest or the group including the user. The user identifier information uniquely identifies the user to manage purchase history.

The user can view received recordings (S500). The user can also modify and decorate the recordings as shown in FIGS. 2 and 7, if the recordings are permitted to modify (S500). The modification can be performed on the user device 150 as well as on the system. The user can preview images of recordings before purchasing the recordings. It allows the system to suggest uncertain recordings as candidate images, each of which can possibly correspond to the user. Therefore, the user can choose recordings from candidate images among a large number of images captured in the ride.

FIG. 15 shows an exemplary system overview according to embodiments of the present disclosure. The system 100 includes one or more cameras 115. One camera of the cameras 115 is disposed at the ride/attraction and another camera is disposed at the gate (entrance) of the park. Cameras (devices) 115 may capture images or movies of guests. A ticket reader at the gate reads the ticket to acquire the ticket serial to identify the ticket. The system 100 also includes communication apparatus 220 in the park. The communication apparatus 220 can communicate with the user device 150. The communication apparatus 220 may identify the user device. The system 100 includes a network interface to communicate with a public network (e.g., the internet). The user can request recordings from the user device 150 to the system 100 via the public network and the network interface. The user device 150 can capture the user and the ticket.

As described above, the user information manager 200 allows tagging each recording to identify corresponding guest and user (tagged user information). The tagged user information helps user of the user device 150 to search recordings corresponding to the user. The user can organize available recordings according to the tagged user information, timestamp and ride identifier of each recording.

The user information manager 200 controls a permission of access request by the user in accordance with the location of the user device 150. This makes the user view, including image or sound of the user experience of ride, in the limited area. The limited area includes, for example, all area in the park, an area around the ride or at the table of a restaurant in the park. In some cases, the access request for the recordings by the user may be denied according to the user's location. The permission can be obtained to the user by purchasing items or services. The user information manager 200 acquires payment information of the user to determine whether permission outside the area can be issued.

The user information manager 200 may identify the user of the user device 150 requesting for the recordings. For example, the user device 150 can take a photo of the user by using built-in camera of the user device. The application, installed on the user device, may transfer the photo image or a set of feature values based on the photo to the user information manager 200. Another example is that the user device 150 acquires an identifier, i.e., the ticket serial number which the user used for entering the park. The system may identify the user by using the ticket serial number by receiving such information and controls permission to access the recordings.

The user information manager 200 may further store user cluster information 213, as shown in FIG. 13. The user cluster information 213 is used for specifying a candidate group of users. For example, when user A, user B and user C are in a group, the users may take on the same ride. By grouping the users according to the cluster information, enhancements (e.g., decorations or filters applied on the recordings) can be shared among the group. The purchasing history and recordings can also be shared among the group.

The user cluster information 213 indicates a group of users who have rode on the same ride. The permission of access from the user device to the recordings is controlled further based on the user cluster information 213. For example, a user, not sharing an experience of a ride, may be permitted to access the recordings of the group to which the user belongs.

The user cluster information 213 can be obtained from a variety of information sources. For example, an application and payment history of tickets, activity traces in the park or an activity history of a ride. When a plurality of tickets is ordered in a single transaction, the users enter the park with the tickets are assumed to be in a group. When a cluster of users takes on the same ride, the users are assumed to be in a group. When the cluster of users is found to take more rides together, the accuracy of the user cluster information 213 is improved.

The user information manager 200 may modify the user cluster information 213 according to the captured image. Users on the same ride are captured by the camera 115. Therefore, a set of users for improving accuracy of the user cluster information 213 can be acquired by person recognition based on the captured images of each ride.

The user cluster information 213 can be modified by a user operation. The user can manually add or remove a candidate user of the group via the application of the user device 150.

The automated image capture and distribution system 200 include an image display device 221 which is coupled to a communication apparatus 220. The image display device 221 is capable of displaying the recordings when the user device is connected to the communication apparatus 220. The communication apparatus 220 is preferably a NFC terminal in this configuration. For example, the communication apparatus 220 is provided at exit of a ride or on table in restaurant. The image display device provides recordings of the user, corresponding to the user device which is connecting with the communication apparatus 220. The image display device 221 may provide a part of an interface for purchasing items or services of the recordings.

When the user device 150 is directly connected to the communication apparatus 220, the image display device is capable of displaying the recordings of the user corresponding to the user device. The user device connects to the communication apparatus 220 directly, including wireless and wired, recordings to be displayed on the image display can be specified using the user information of the user device.

The above configured system improves accessibility of the user for the recordings. The guest captured by camera 115 may be automatically identified as the user on the record. Therefore, the user may access to the recordings that the user experienced. In other words, the user does not have to search the recordings from a lot of images captured by the camera 115. Therefore, the user can find captured images of the user even after the user exits the park. In other words, the user can make decision of purchasing the recordings not only just after the ride experience but also at any time after the ride experience.

In the park, access permission for recordings of the user can be controlled. For example, the user may be allowed to access all recordings related to the user and clusters which the user is included. The permission of the user can also be controlled according to the payment history outside the park. Therefore, the user can make decision of purchasing the recordings viewing the recordings as long as the user device can communicate with the communication apparatus 220 of the park.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for automatically documenting a user's experience on a ride, the system comprising:
a user device that includes:
user information, wherein the user information is transmitted to a capture and distribution system, and wherein the user information is used to uniquely identify the user in one or more recordings, and
an application that facilitates receiving user input, wherein the user input includes requesting recordings and modifications to existing recordings to be performed;
a plurality of devices associated with a ride that document the user's experience on that ride in a recording; and
a processor that executes instructions stored in memory, the instructions being executed by the processor to:
identify one or more users in the recording provided by the plurality of devices,
tag the recording with the identified user identification, wherein the tagged user information is used to organize and/or search for recordings when requested by the user,
store the tagged recordings into memory,
implement one or more modifications to the tagged recording based on the user information, wherein the modified recordings are stored alongside unmodified tagged recordings in memory,
retrieve user information that identify where the tagged recordings should be transmitted, and
transmit the tagged recording to the user device.

2. The system of claim 1, wherein the plurality of devices includes cameras and microphones.

3. The system of claim 1, wherein documentation of the user's experience includes images, video, and audio recordings.

4. A system for automatically documenting a user's experience on a ride, the system comprising:
an user information manager for managing user information which is used to uniquely identify the user in one or more recordings;
a plurality of devices associated with a ride that document the user's experience on that ride in a recording; and
a processor that executes instructions stored in a memory, the instructions, when executed by the processor, causes the processor to:
identify one or more users in the recording provided by the plurality of devices,
store the recording into memory,
tag the recording with the user information of an identified user, wherein the tagged user information is used to organize or search for recordings when requested by the user,
receive user information being transmitted from the user device, and
determine permission of access for the recording based on the tagged user information and the user information transmitted from the user, wherein:
the plurality of devices include cameras, each of which captures an image, and
the user information manager identifies the user and a person in the image based on the user information and the image.

5. The system of claim 4, wherein:
the user information manager includes a user information database, and
the user information database includes:
user identifier information which uniquely identifies the user, and
at least one piece of face image information related to the user.

6. The system of claim 4, further comprising
a communication apparatus for communicating with the user device,
wherein the user information manager controls a permission of access from the user device to the recording.

7. The system of claim 6, wherein:
the user information manager further includes user cluster information,
the user cluster information indicates a group of users who have rode on a same ride, and
the permission of access from the user device to the recording is further controlled based on the user cluster information.

8. The system of claim 7, wherein
the user information manager modifies the user cluster information based on the image which includes the group of users.

9. The system of claim 6, further comprising
an image display device which is related to the communication apparatus,
wherein the image display device is configured to display the recordings when the user device is connected to the communication apparatus.

10. The system of claim 4, wherein:
the user device further includes an application that facilitates receiving user input, and
the user input includes a request for recording and implementing modification to the recording to be performed.

11. The system of claim 4, further comprising:
a communication apparatus for communicating with the user device; and
an image display device which is coupled to the communication apparatus,
wherein the image display device is configured to display the recording of the user corresponding to the user device, when the user device is connecting to the communication apparatus.
